(19) United States
(12) Patent Application Publication
(10) Pub. No.: US 2012/0176308 A1
(43) Pub. Date: Jul. 12, 2012

(54) METHOD FOR SUPPORTING MULTIPLE MENUS AND INTERACTIVE INPUT SYSTEM EMPLOYING SAME

(75) Inventors: CHRIS WESTERMANN, Calgary (CA); KEITH WILDE, Calgary (CA); QINGYUAN ZENG, Calgary (CA); KATHRYN ROUNDING, Calgary (CA); ANN DANG PHAM, Calgary (CA)

(73) Assignee: SMART TECHNOLOGIES ULC, Calgary (CA)

(21) Appl. No.: 13/349,166

(22) Filed: Jan. 12, 2012

Related U.S. Application Data
(60) Provisional application No. 61/431,848, filed on Jan. 12, 2011.

(51) Int. Cl. G09G 5/00

(52) U.S. Cl. 345/156

(57) ABSTRACT

A method comprises receiving an input event associated with a first user ID, the input event being a command for displaying a first menu on a display surface; identifying a second menu associated with the first user ID currently being displayed on the display surface; dismissing the second menu; and displaying the first menu.

### CROSS-REFERENCE TO RELATED APPLICATIONS

This application claims the benefit of U.S. Provisional Application No. 61/431,848 entitled “METHOD OF SUPPORTING MULTIPLE SELECTIONS AND INTERACTIVE INPUT SYSTEM EMPLOYING SAME”, filed on Jan. 12, 2011, the content of which is incorporated herein by reference in its entirety. This application is also related to U.S. Provisional Application No. 61/431,853 entitled “METHOD OF SUPPORTING MULTIPLE SELECTIONS AND INTERACTIVE INPUT SYSTEM EMPLOYING SAME”, filed on Jan. 12, 2011, the content of which is incorporated herein by reference in its entirety.

### FIELD OF THE INVENTION

The present invention relates generally to interactive input systems, and in particular to a method and apparatus for supporting multiple menus and an interactive input system employing same.

### BACKGROUND OF THE INVENTION

Application programs running on computing devices such as for example, computer servers, desktop computers, laptop and notebook computers, personal digital assistants (PDAs), smartphones, or the like commonly use menus for presenting lists of selectable commands. Many Internet websites also use menus, which are loaded into a web browser of a client computing device when the browser accesses such a website. Some operating systems, such as for example Microsoft® Windows, Apple MacOS and Linux, also use menus.

Typical menu structures comprise a main menu, toolbar menus and contextual menus. The main menu often comprises a plurality of menu items, each associated with a respective command. Items of the main menu are usually organized into different menu groups (sometimes referred to simply as “menus”) where each menu group has a representation in the form of a text string or an icon. In some application programs, menu group representations are arranged in a row or column within an application window so as to form a menu bar. During interaction with such a menu bar, a user may select a menu group by clicking on the menu group representation, or by pressing a shortcut key to open the respective menu group, and may then select a menu item of the menu group to execute the command associated therewith.

The toolbar menu is typically associated with a tool button on a toolbar. When the tool button is selected, the toolbar menu associated with that tool button is opened and one or more selectable menu items or tool buttons comprised therein are displayed, each being associated with a respective command.

The contextual menu, sometimes referred to as a “popup” menu, is a menu associated with an object in an application window. Contextual menus may be opened by, for example, clicking a right mouse button on the object, or by clicking on a control handle associated with the object. When a contextual menu is opened, one or more selectable menu items are displayed, each being associated with a respective command.

Prior art menu structures generally only allow one menu to be opened at a time. For example, a user of a prior art application program may click the right mouse button on an image object to open a contextual menu thereof. However, when the user clicks on the “File” menu representation in the menu bar, the contextual menu of the image object is dismissed before the “File” menu is opened. Such a menu structure may be adequate when only a single user is operating a computing device running the application program. However, when multiple users are operating the computing device at the same time, such a menu structure may disrupt collaboration between the users.

Improvements are therefore desired. Accordingly, it is an object to provide a novel method and apparatus for supporting multiple menus and a novel interactive input system employing same.

### SUMMARY OF THE INVENTION

Accordingly, in one aspect there is provided a method comprising receiving an input event associated with a first user ID, the input event being a command for displaying a first menu on a display surface; identifying a second menu associated with the first user ID currently being displayed on the display surface; dismissing the second menu; and displaying the first menu.

In one embodiment, the method further comprises receiving an input event associated with a second user ID, the input event being a command for displaying a third menu on the display surface, identifying a fourth menu associated with the second user ID currently being displayed on the display surface, dismissing the fourth menu and displaying the third menu.

The second user ID may be associated with one of a mouse and a keyboard and the first user ID may be associated with an input ID and a display surface ID. The input ID identifies the input source and the display surface ID identifies an interactive surface on which pointer input is received. The first and second menus comprise one of a main menu bar, a contextual menu and a toolbar menu.

According to another aspect, there is provided an interactive input system comprising at least one interactive surface; and processing structure in communication with said at least one interactive surface and being configured to generate an input event associated with a first user ID, the input event being a command for displaying a first menu on the interactive surface; identify a second menu associated with the first user ID currently being displayed on the interactive surface; dismiss the second menu; and display the first menu.

According to yet another aspect, there is provided a non-transitory computer-readable medium having embodied thereon a computer program comprising instructions which, when executed by processing structure, carry out the steps of receiving an input event associated with a first user ID, the input event being a command for displaying a first menu on a display surface; identifying a second menu associated with the first user ID currently being displayed on the display surface; dismissing the second menu; and displaying the first menu.

According to still yet another aspect, there is provided an apparatus comprising processing structure; and memory storing program code, which when executed by the processing structure, causes the processing structure to direct the apparatus to in response to receiving an input event associated with a first user ID representing a command for displaying a first menu on a display surface, identify a second menu associated with the first user ID currently being displayed on the display surface; dismiss the second menu; and display the first menu.

### BRIEF DESCRIPTION OF THE DRAWINGS

Embodiments will now be described more fully with reference to the accompanying drawings in which:

FIG. 1 is a perspective view of an interactive input system;

FIG. 2 is a block diagram of a software architecture used by the interactive input system of FIG. 1;

FIGS. 3A to 3C are block diagrams of a main menu, a contextual menu and a toolbar menu, respectively, forming a menu structure used by the interactive input system of FIG. 1;

FIG. 4 is a block diagram of a menu format used in the menu structure of FIGS. 3A to 3C;

FIG. 5 is a block diagram of an exemplary class architecture for displaying the menu structure of FIGS. 3A to 3C;

FIG. 6 is a flowchart showing the steps of a multiple menu support method used by the interactive input system of FIG. 1;

FIG. 7 is a flowchart showing the steps of an input association process forming part of the multiple menu support method of FIG. 6;

FIG. 8 is a flowchart showing the steps of a menu manipulation process forming part of the multiple menu support method of FIG. 6;

FIG. 9 is a flowchart showing the steps of a menu dismissal process forming part of the menu manipulation process of FIG. 8;

FIG. 10 is a flowchart showing the steps of a menu opening and association process forming part of the menu manipulation process of FIG. 8;

FIG. 11 is an application program window presented by the interactive input system of FIG. 1;

FIG. 12 is the application program window of FIG. 11, having been updated after an input event on a toolbar;

FIG. 13 is the application program window of FIG. 12, having been updated after an input event on a main menu bar;

FIG. 14 is the application program window of FIG. 13, having been updated after an input event on a graphic object;

FIG. 15 is the application program window of FIG. 14, having been updated after an input event on another graphic object; and

FIG. 16 is the application program window of FIG. 15, having been updated after an input event in a drawing area.

### DETAILED DESCRIPTION OF THE EMBODIMENTS

In the following, a method and apparatus for supporting multiple menus are described. The method comprises receiving an input event associated with a first user ID, the input event being a command for displaying a first menu a display surface; identifying a second menu associated with the first user ID currently being displayed on the display surface; dismissing the second menu; and displaying the first menu.

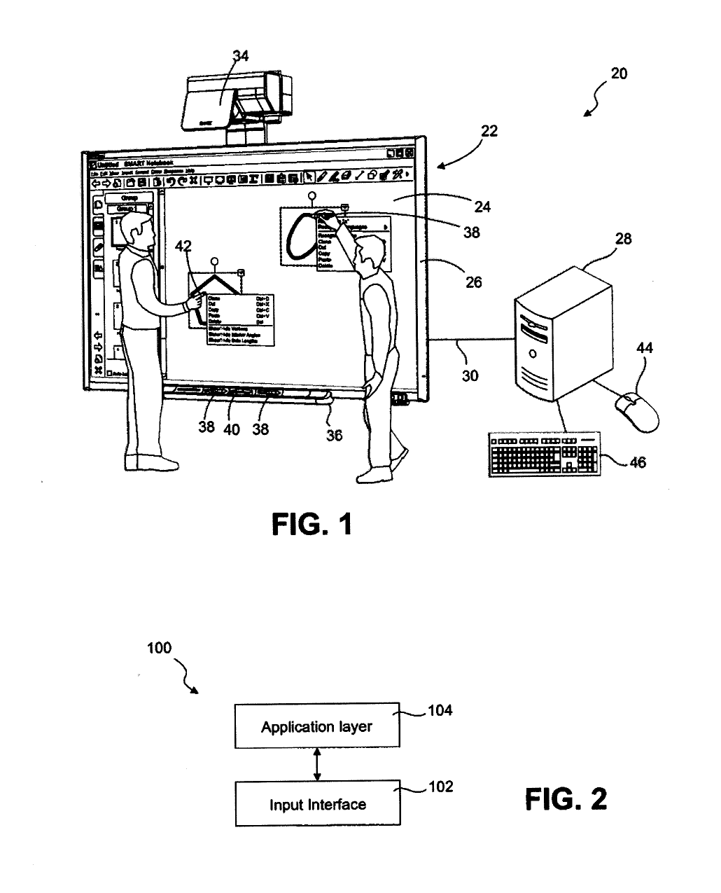

Turning now to FIG. 1, an interactive input system is shown and is generally identified by reference numeral 20. Interactive input system 20 allows one or more users to inject input such as digital ink, mouse events, commands, etc. into an executing application program. In this embodiment, interactive input system 20 comprises a two-dimensional (2D) interactive device in the form of an interactive whiteboard (IWB) 22 mounted on a vertical support surface such as for example, a wall surface or the like. IWB 22 comprises a generally planar, rectangular interactive surface 24 that is surrounded about its periphery by a bezel 26. An ultra-short-throw projector 34 such as that sold by SMART Technologies ULC of Calgary, Alberta, Canada under the name “SMART UX60”, is also mounted on the support surface above the IWB 22 and projects an image, such as for example, a computer desktop, onto the interactive surface 24.

The IWB 22 employs machine vision to detect one or more pointers brought into a region of interest in proximity with the interactive surface 24. The IWB 22 communicates with a general purpose computing device 28 executing one or more application programs via a universal serial bus (USB) cable 30 or other suitable wired or wireless communication link. Computing device 28 processes the output of the IWB 22 and adjusts image data that is output to the projector 34, if required, so that the image presented on the interactive surface 24 reflects pointer activity. In this manner, the IWB 22, computing device 28 and projector 34 allow pointer activity proximate to the interactive surface 24 to be recorded as writing or drawing or used to control execution of one or more application programs executed by the computing device 28.

The bezel 26 is mechanically fastened to the interactive surface 24 and comprises four bezel segments that extend along the edges of the interactive surface 24. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 24.

A tool tray 36 is affixed to the IWB 22 adjacent the bottom bezel segment using suitable fasteners such as for example, screws, clips, adhesive etc. As can be seen, the tool tray 36 comprises a housing having an upper surface configured to define a plurality of receptacles or slots. The receptacles are sized to receive one or more pen tools 38 as well as an eraser tool 40 that can be used to interact with the interactive surface 24. Control buttons are also provided on the upper surface of the tool tray housing to enable a user to control operation of the interactive input system 20. Further specifies of the tool tray 36 are described in U.S. Patent Application Publication No. 2011/0169736 to Bolt et al., filed on Feb. 19, 2010, and entitled “INTERACTIVE INPUT SYSTEM AND TOOL TRAY THEREFOR.

Imaging assemblies (not shown) are accommodated by the bezel 26, with each imaging assembly being positioned adjacent a different corner of the bezel. Each of the imaging assemblies comprises an image sensor and associated lens assembly. The lens has an IR-pass/visible light blocking filter thereon and provides the image sensor with a field of view sufficiently large as to encompass the entire interactive surface 24. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 24 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes reflected IR illumination and appears as a dark region interrupting the bright band in captured image frames.

The imaging assemblies are oriented so that their fields of view overlap and look generally across the entire interactive surface 24. In this manner, any pointer such as for example a user's finger 42, a cylinder or other suitable object, a pen tool 38 or an eraser tool 40 lifted from a receptacle of the tool tray 36, that is brought into proximity of the interactive surface 24 appears in the fields of view of the imaging assemblies and thus, is captured in image frames acquired by multiple imaging assemblies. When the imaging assemblies acquire image frames in which a pointer exists, the imaging assemblies convey pointer data to the computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The computing device 28 may also comprise networking capabilities using Ethernet, WiFi, and/or other suitable network format, to enable connection to shared or remote drives, one or more networked computers, or other networked devices. A mouse 44 and a keyboard 46 are coupled to the general purpose computing device 28.

The computing device 28 processes pointer data received from the imaging assemblies to reject pointer ambiguity by combining the pointer data detected by the imaging assemblies, and to compute the locations of pointers proximate the interactive surface 24 using well known triangulation. The computed pointer locations are then recorded as writing or drawing or used as one or more input commands to control execution of an application program as described above.

In addition to computing the locations of pointers proximate to the interactive surface 24, the general purpose computing device 28 also determines the pointer types (e.g., a pen tool, a finger or a palm) by using pointer type data received from the IWB 22. The pointer type data is generated for each pointer contact by the DSP of at least one of the imaging assemblies. The pointer type data is generated by differentiating a curve of growth derived from a horizontal intensity profile of pixels corresponding to each pointer tip in the captured image frames. Specifics of methods used to determine pointer type are disclosed in U.S. Pat. No. 7,532,206 to Morrison, et al., and assigned to SMART Technologies ULC, Calgary, Alberta, Canada, the assignee of the subject patent application, the content of which is incorporated herein by reference in its entirety.

FIG. 2 shows the software architecture used by the interactive input system 20, and which is generally identified by reference numeral 100. The software architecture 100 comprises an input interface 102, and an application layer 104 comprising an application program. The input interface 102 is configured to receive input from various input sources generated from the input devices of the interactive input system 20. In this embodiment, the input devices include the IWB 22, the mouse 44, and the keyboard 46. The input interface 102 processes each input received and generates an input event. In generating each input event, the input interface 102 generally detects the identity of the input received based on input characteristics, and assigns to each input event an input ID, a surface ID and a contact ID. In this embodiment, if the input event is not the result of pointer input originating from the IWB 22, the values of the surface ID and contact ID assigned to the input event are set to NULL.

The input ID identifies the input source. If the input originates from mouse 44 or the keyboard 46, the input ID identifies that input device. If the input is pointer input originating from the IWB 22, the input ID identifies the type of pointer, such as for example a pen tool, a finger or a palm. In this case, the surface ID identifies the interactive surface on which the pointer input is received. In this embodiment, IWB 22 comprises only a single interactive surface 24, and therefore the value of the surface ID is the identity of the interactive surface 24. The contact ID identifies the pointer based on the location of pointer input on the interactive surface 24.

Table 1 below shows a listing of exemplary input sources, and the IDs used in the input events generated by the input interface 102.

TABLE 1

| Input Source | IDs of Input Event |
|---|---|
| Keyboard | {input ID, NULL, NULL} |
| Mouse | {input ID, NULL, NULL} |
| Pointer contact on IWB | {input ID, surface ID, contact ID} |

The input interface 102 also associates each input event to a respective user and thus, each user is assigned a unique user ID. In this embodiment, the user ID is assigned based on both the input ID and the surface ID. For example, a pen tool and a finger contacting the interactive surface 24 at the same time will be assigned different user IDs. As another example, two fingers contacting the interactive surface 24 at the same time will be assigned the same user ID, although they will have different contact IDs. In this embodiment, a special user, denoted as unknown user and assigned with a NoUserID user ID, is predefined. As mouse 44 and keyboard 46 are devices that may be used by any user, in this embodiment, input interface 102 associates input from these devices with the NoUserID user ID. Once an input event has been generated, the input interface 102 communicates the input event and the user ID to the application program running on the computing device 28.

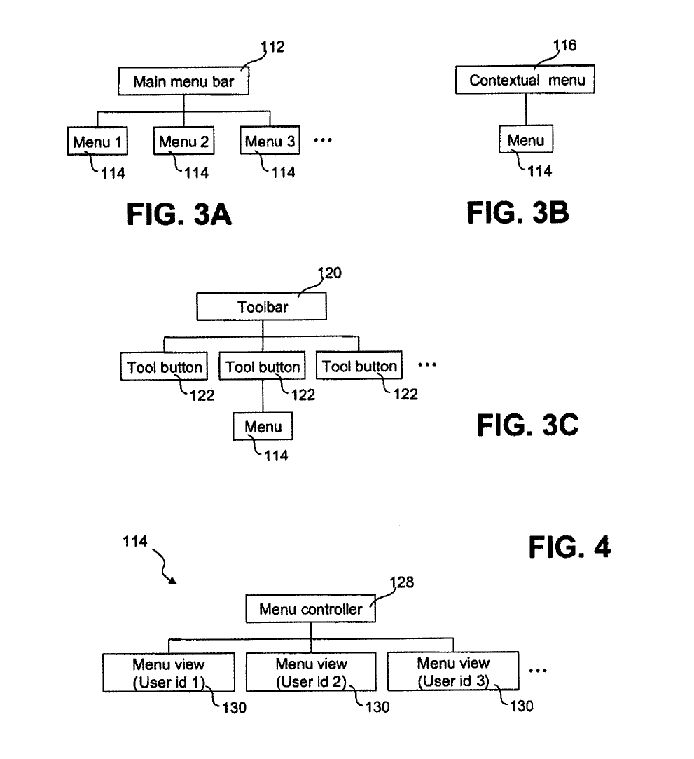

FIGS. 3A to 3C show a menu structure used by the interactive input system 20. In this embodiment, the menu structure comprises a main menu bar 112, a contextual menu 116 and a toolbar 120, as shown in FIGS. 3A, 3B and 3C, respectively. In the embodiment shown, the main menu bar 112 comprises multiple menus 114, while the contextual menu 116 comprises a single menu 114. The toolbar 120 comprises one or more tool buttons 122. At least one of the tool buttons 122 is configured to open an associated menu 114 when selected.

FIG. 4 shows the menu format of each menu 114 forming part of the menu structure, and which is generally referred to by reference numeral 126. Each menu 114 comprises a menu controller 128 and one or more menu view objects 130. Each menu view object 130 is a graphic object displayed on the interactive surface 24. Each of the menu objects is associated with a unique user ID, and which may be the NoUserID user ID. The menu controller 128 is configured to control the display of menu view objects 130 on the interactive surface 24, and is generally configured to allow multiple users to each access the same menu 114 at the same time, as is further described below. Accordingly, during multiple user collaboration, the menu controller 128 displays multiple menu view objects 130, each associated with a respective user ID, on the interactive surface 24 such that the multiple menu view objects 130 do not occlude each other.

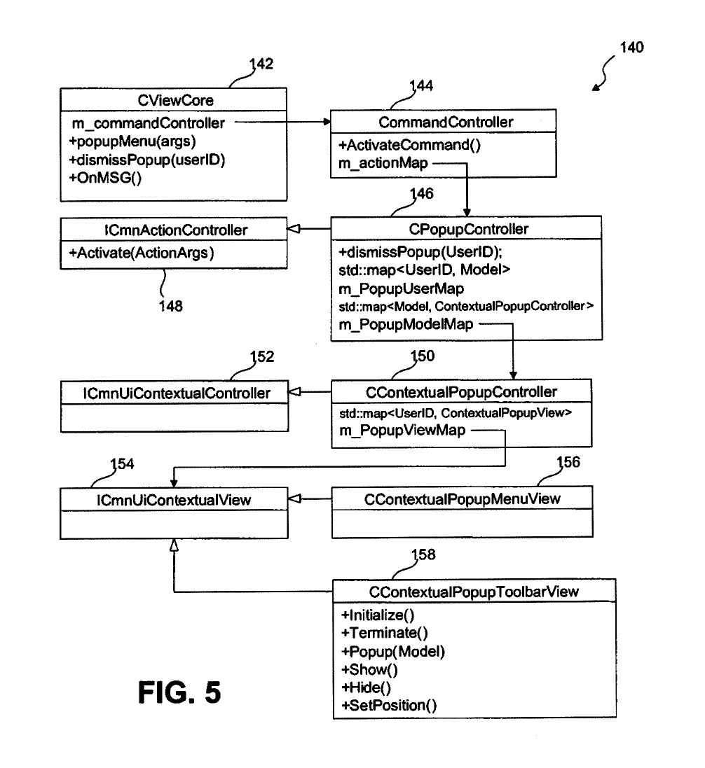

FIG. 5 shows a diagram of an exemplary class architecture used by an application program running on the Microsoft® Window XP operating system installed on computing device 28 to display the menu structure used by the interactive input system 20, and which is generally referred to by reference numeral 140. Class architecture 140 comprises a CViewCore 142 that controls the display of the window of the application program, including the display and the dismissal of menus. The class CViewCore 142 is configured to receive a request from the application program with both an indication of the action of opening a menu and the associated user ID, as indicated by the parameter userID, and to dismiss any currently open menus associated with the user ID.

The class CViewCore 142 is associated with a class CommandController 144 via a parameter m_commandcontroller. The class CommandController 144 is in turn associated with a class CPopupController 146 via a parameter m_actionMap. The class CPopupController 146, which is inherited from a class ICmnActionController 148, provides a public function dismissPopup(UserID) that may be called by the CommandController 144 to dismiss any menus associated with the UserID. The class CPopupController 146 also comprises a map (UserID, Model) for recording the association of user IDs and menus, where Model is the ID of a menu. The class CPopupController 146 further comprises a map (Model, ContextualPopupController) for recording the association of menus and the corresponding menu controller objects ContextualPopupController created from a class ContextualPopupController 150. The class CPopupController 146 is associated with the class CContextualPopupController 150 via the parameter m_PopupModelMap.

The class CContextualPopupController 150, which is inherited from a class ICmnUiContextualController 152, comprises a map (UserID, ContextualPopupView) for recording the association of user IDs and the menu view objects 130, which are collectively denoted as ContextualPopupView.

In this embodiment, the menu view objects 130 of menus 114 of contextual menus 116 and menus 114 of the main menu bar 112 are created from a class CContextualPopupMenuView 156, and the menu view objects 130 of menus 114 of the toolbar 120 are created from a class CContextualPopupToolbarView 158. Both classes CContextualPopupMenuView 156 and CContextualPopupToolbarView 158 are inherited from the class ICmnUiContextualView 154, and are linked to class CContextualPopupController 150 via the association from class CContextualPopupController 150 to class ICmnUiContextualView 154 via the parameter m_PopupViewMap.

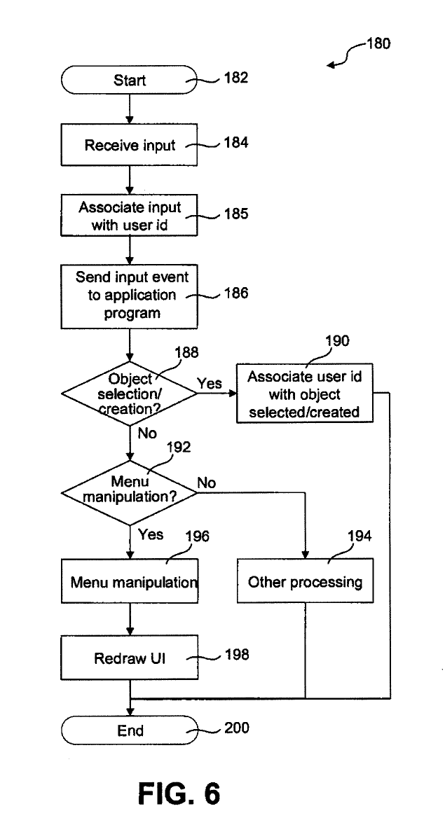

FIG. 6 is a flowchart showing the steps of a multiple menu support method used by the interactive input system 20, and which is generally referred to by reference numeral 180. In this embodiment, the multiple menu support method 180 is carried out by the computing device 28. The input interface 102 comprises a SMART Board driver and the application program running on the computing device 28 comprises SMART Notebook™ offered by SMART Technologies ULC of Calgary, Alberta, Canada. When the input interface 102 first receives input from an input source (step 184), the input interface 102 generates an input event comprising an input ID, a surface ID and a contact ID, and associates the input event with a user ID (step 185).

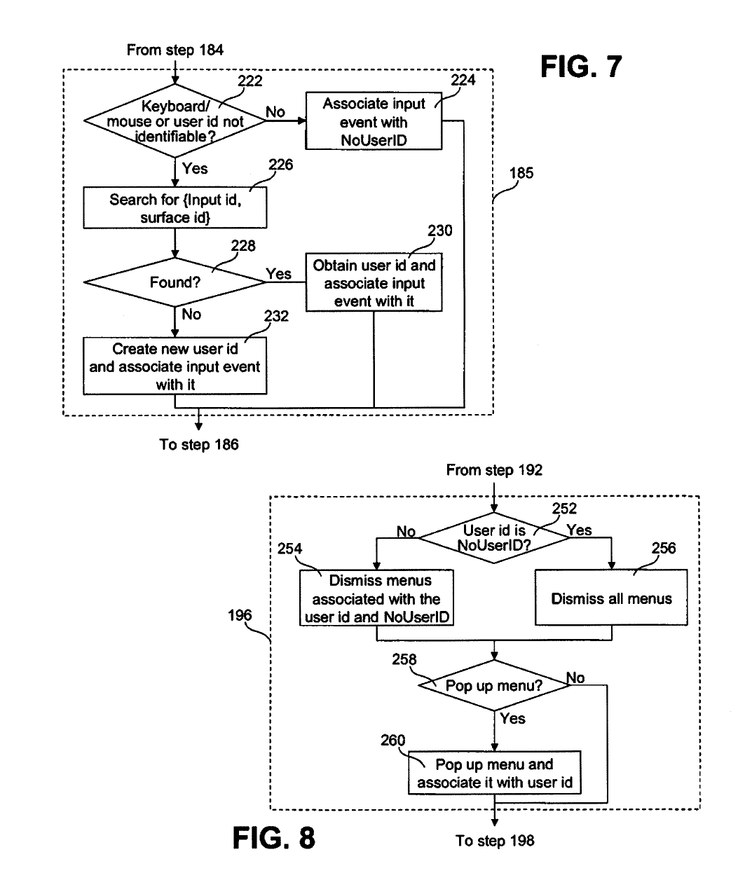

The input association process carried out in step 185 is better shown in FIG. 7. In this step, the input interface 102 first determines if the input event is from an input device for which the user identity cannot be identified (step 222). As mentioned above, in this embodiment, these input devices are the mouse 44 and the keyboard 46. If the input event is from such an input device, the input interface 102 associates the input event with the NoUserID user ID (step 224). The process then proceeds to step 186 in FIG. 6.

If it is determined at step 222 that the input event is from a device for which the user identity can be identified, such as for example IWB 22, the input interface 102 searches for a user ID based on both the input ID and the surface ID (step 226). If a user ID corresponding to the input ID and surface ID is found (step 228), the input interface 102 associates the input event with that user ID (step 230). The process then proceeds to step 186 in FIG. 6. If at step 228 a user ID corresponding to the input ID and surface ID is not found, the input interface 102 creates a new user ID, and associates the input event with the new user ID. The process then proceeds to step 186 in FIG. 6.

Turning again to FIG. 6, following step 185, the input interface 102 then sends the input event and the associated user ID to the application program (step 186). Upon receiving the input event, the application program determines if the input event corresponds to a command of selecting or creating an object (step 188). The object may be, for example, a digital ink annotation, a shape, an image, a Flash object, or the like. If the input event corresponds to a command for selecting or creating an object, the application program performs the selection or creation of the designated object as indicated by the input event, and associates the selected/created object with the user ID (step 190). The process then ends (step 200).

If, at step 188, it is determined that the input event does not correspond to a command for selecting or creating an object, the application program determines if the input event corresponds to a command for menu manipulation (step 192). If the input event does not correspond to a command for menu manipulation, the type of the input event is then determined and the input event is processed in accordance with that type (step 194). The process then ends (step 200).

If, at step 192, it is determined that the input event corresponds to a command for menu manipulation, the application program then manipulates the menu according to a set of menu manipulation rules (step 196), following which the process ends (step 200).

Menu manipulation rules may be defined in the application program either at the design stage of the application program, or later through modification of the application program settings. In this embodiment, the application program uses the following menu manipulation rules:

a) different users may open menus at the same time; however, each user can open only one menu at a time;

b) a user can dismiss only the currently open menu that is associated with either his/her user ID or with NoUserID;

c) an input event for menu manipulation that is associated with the user ID NoUserID applies to all menus associated with any user (e.g. an input event to dismiss a menu associated with NoUserID will dismiss menus associated with any user); and

d) although it may be assigned to multiple inputs, each user ID, including NoUserID, is treated as a single user.

The menu manipulation process carried out in step 196, and in accordance with the above-defined menu manipulation rules, is shown in FIG. 8. In the embodiment shown, only the steps of opening and dismissing a menu are illustrated. Other menu manipulation actions, such as for example selecting a menu item to execute an associated command, are well known in the art and are therefore not shown.

At step 252, the application program determines if the user ID associated with the input event is NoUserID. If the user ID is not NoUserID, the application program then dismisses the menu associated with the user ID, together with the menu associated with NoUserID, if any of these menus are currently displayed on the interactive surface 24 (step 254). In this case, each menu associated with NoUserID is first deleted. Each menu associated with the user ID is then no longer displayed on the interactive surface 24, and is associated with the user ID NoUserID so that it is available for use by any user ID. The process then proceeds to step 258.

If at step 252 the user ID associated with the input event is NoUserID, the application program 104 dismisses all open menus associated with any user ID (step 256). Here, any menu associated with NoUserID is first deleted. Remaining menus associated with any user ID are then no longer displayed on the interactive surface 24, and are associated with the NoUserID so they are available for use by any user ID. The process then proceeds to step 258.

At step 258, the application program determines if the input event is a command for opening a menu. If the input event is not a command for opening a menu, the process proceeds to step 198 in FIG. 6; otherwise, the application program opens the menu, and assigns it to the user ID that is associated with the input event (step 260). At this step, the application program first searches for the requested menu in hidden menus associated with NoUserID. If the requested menu is found, the application program then displays the menu view object at an appropriate location, and associates it with the user ID. In this embodiment, the appropriate location is one that is generally proximate to the contact location associated with the input event, and one that does not occlude any other menu view object currently displayed. If the requested menu is not found, the application program creates the requested menu view object, displays it at the appropriate location of the interactive surface 24, and associates it with the user ID.

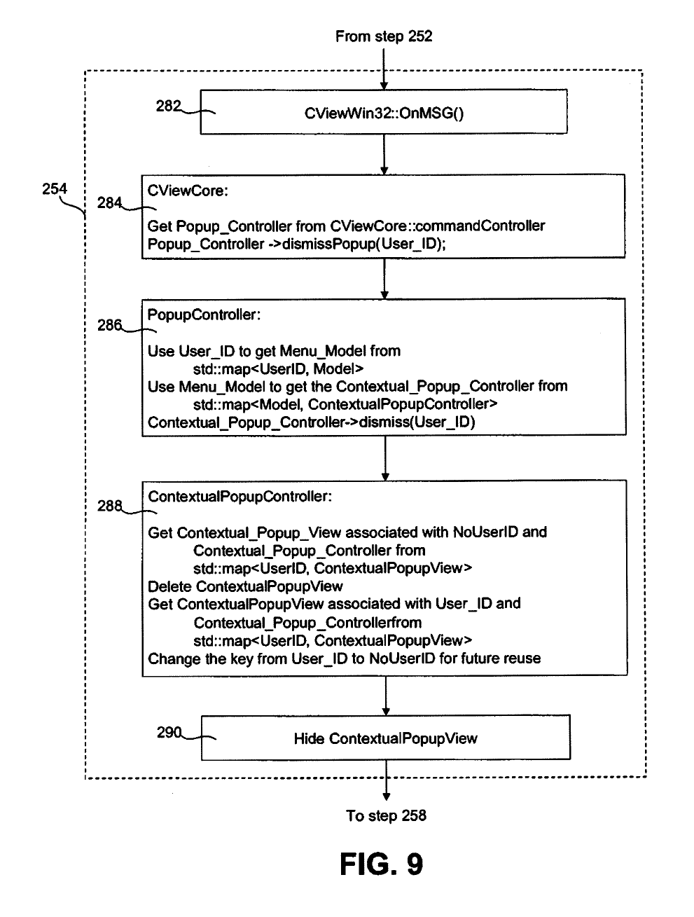

The menu dismissal process carried out in step 254 is better shown in FIG. 9. This process is carried out by the application program using the exemplary class architecture shown in FIG. 5. The OnMSG( ) function of class CViewWin32 (not shown in FIG. 5) is first called in response to an input event associated with a user ID User_ID received from the input interface 102 (step 282).

As a result, the functions in class CViewCore are executed to obtain the pointer Popup_Controller to the popup controller object PopupController (created from class CPopupController) from CViewCore::commandController, and to call the dismissPopup( ) function of object PopupController with the parameter of User_ID (step 284).

Consequently, at step 286, functions in object PopupController are executed to obtain Menu_Model by searching User_ID in the map (UserID, Model). Here, the Menu_Model is the Model of the menu associated with User_ID. A pointer Contextual_Popup_Controller to the menu controller ContextualPopupController is then obtained by searching Menu_Model in the map (Model, ContextualPopupController). Then, object PopupController calls the function dismiss( ) of the menu controller ContextualPopupController (created from class CContextualPopupController) with the parameter of User_ID.

At step 288, functions in the menu controller object ContextualPopupController are executed to obtain the pointer Contextual_Popup_View to the menu view object ContextualPopupView associated with the menu controller ContextualPopupController and the special user ID NoUserID from the map (UserID, ContextualPopupView). The obtained ContextualPopupView, if any, is then deleted. As a result, the menu currently popped up and associated with NoUserID is dismissed. Then, the ContextualPopupView associated with both the menu controller ContextualPopupController and the user ID UserID is obtained by searching UserID in the map (UserID, ContextualPopupView). The ContextualPopupView obtained is then assigned the user ID NoUserID so that it is available for reuse by any user of the application program.

At step 290, the ContextualPopupView obtained is hidden from display. As a result, the menu that is currently open and associated with UserID is then dismissed.

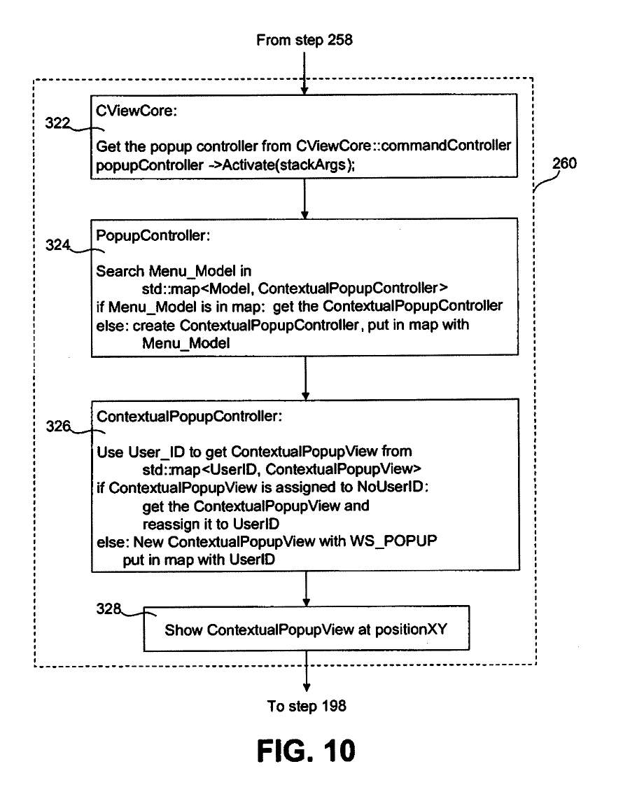

The menu opening and association process carried out in step 260 is better shown in FIG. 10. This process is carried out by the application program using the exemplary class architecture shown in FIG. 5. Functions in class CViewCore are first executed to obtain the pop up controller from CViewCore::commandController (step 322). The Activate( ) function of object PopupController (created from class CPopupController) with parameters stackArgs is called. The parameters stackArgs include Menu_Model, User_ID, and positionXY, which is the position on the interactive surface 24 at which the menu view object is to be displayed.

Consequently, at step 324, functions in object PopupController are executed to search for Menu_Model in the map (Model, ContextualPopupController). If Menu_Model is found, the corresponding ContextualPopupController is obtained; otherwise, a new ContextualPopupController object is created from class CContextualPopupController, and is then added to the map (Model, ContextualPopupController) with Menu_Model.

Each ContextualPopupController object is associated with a corresponding ContextualPopupView object. Therefore, at step 326, functions in object ContextualPopupController are executed to search for the menu view object ContextualPopupView associated with the menu controller ContextualPopupController and the user ID NoUserID in the map (UserID, ContextualPopupView). If such a menu view object ContextualPopupView is found, it is then reassigned to User_ID; otherwise, a new ContextualPopupView object is created with a parameter WS_POPUP, assigned to User_ID, and added to the map (UserID, ContextualPopupView). The menu view object ContextualPopupView is then displayed on the interactive surface 24 at the position positionXY (step 328).

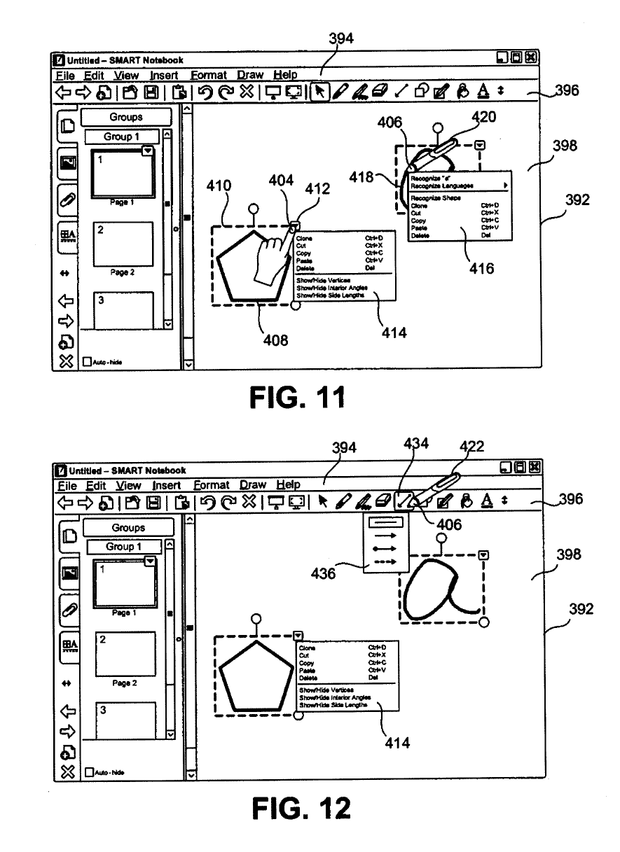

FIG. 11 shows an exemplary application program window presented by the interactive input system 20 and displayed on IWB 22, and which is generally indicated by reference numeral 392. In the embodiment shown, application program window 392 comprises a main menu bar 394, a toolbar 396, and a drawing area 398. The drawing area 398 comprises graphic objects 408 and 418 therein. As shown in FIG. 11, the graphic object 408 has been selected by a previously detected finger contact (not shown). As a result, a bounding box 410 with control handles surrounds the graphic object 408. The application program receives an input event in response to a finger contact 404 on a contextual menu handle 412 of the graphic object 408. As a result, a contextual menu view object 414 is opened in the application window 392 near the contextual menu handle 412. The application program also receives an input event corresponding to a pen contact 406 on the graphic object 418 made using a pen tool 406. Because the user ID associated with the pen contact 406 is different from that associated with the finger contact 404, the input event generated in response to the pen contact 406 does not dismiss the menu view object 414. The pen contact 406 is maintained for a period longer than a time threshold so as to trigger the input interface 102 to generate a pointer-hold event. The pointer-hold event is interpreted by the application program as a request to open the contextual menu of graphic object 418. As a result, a contextual menu view object 416 is displayed near the location of pen contact 406 without dismissing the contextual menu view object 414 opened by the finger contact 404.

The application program window 392 is continually updated during use to reflect pointer activity. In FIG. 12, a pen tool 422 touches an icon 434 located on the toolbar 396. As user ID is based on both the input ID and the surface ID, in the embodiment shown, all pen tools contacting the interactive surface 24 are assigned the same user ID. Therefore, as a result, the application program dismisses the contextual menu view object 416 previously opened by the pen tool 420. In the example shown, the contextual menu view object 416 is hidden and associated with the user ID NoUserID, and is thereby available for any user to reuse. The application program then displays a menu view object 436 associated with the icon 434.

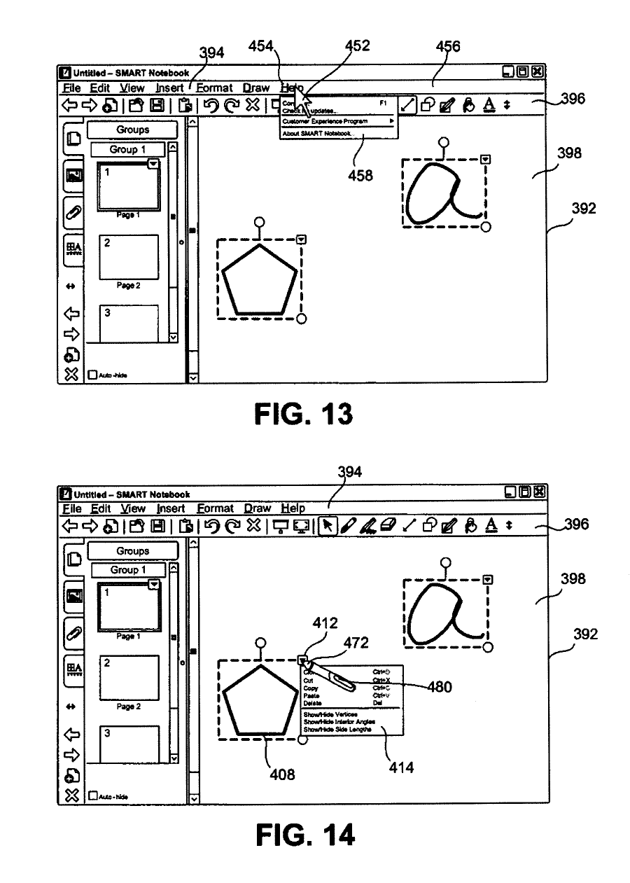

In FIG. 13, the application program receives an input event generated in response to a mouse click represented by arrow 452 on a “Help” menu group representation 454 of the main menu bar 394. Because the mouse 44 is associated with the user ID NoUserID, the mouse click input event causes all menus to be dismissed. In the example shown, the menu view object 416 that has been hidden and associated with NoUserID is deleted, and menu view objects 414 and 436 are hidden and reassigned to NoUserID. The application then opens a “Help” menu view object 458.

The “Help” menu view object 458 is associated with user ID NoUserID. As a result, in FIG. 14, when the application program receives an input event generated in response to a pen contact 472 on the contextual menu handle 412 of the graphic object 408 made using pen tool 480, it deletes the menu view object 458. The application program then finds the hidden menu view object 414, reassigns it to the user ID of the pen tool 480, and displays the menu view object 414 in the application window 392.

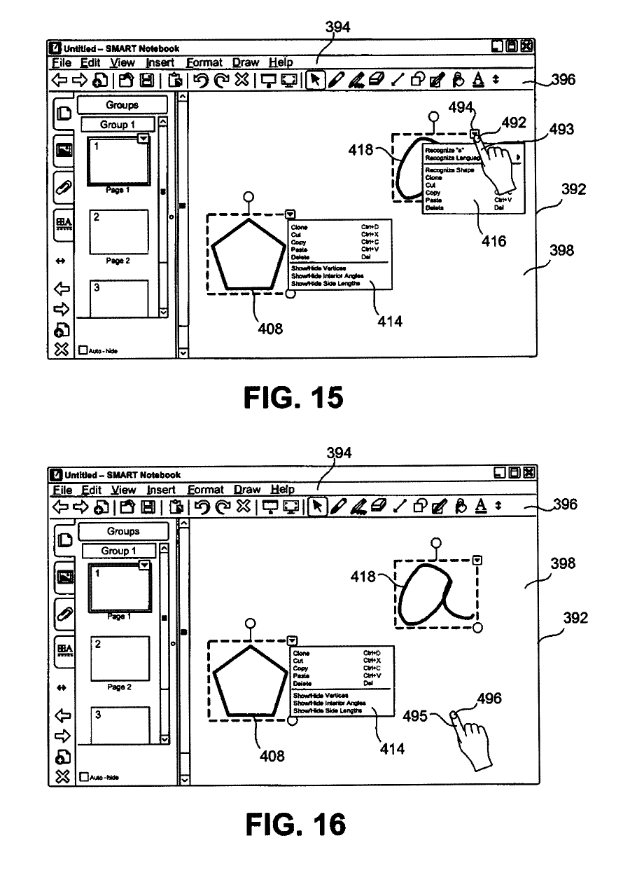

In FIG. 15, the application program receives an input event generated in response to a finger contact 492 on a contextual menu handle 494 of the graphic object 418 made using finger 493. As a result, the application program opens the contextual menu view object 416 of graphic object 418 near the contextual menu handle 494, and without dismissing the contextual menu view object 414 of the graphic object 408.

In FIG. 16, the application program receives an input event 496 generated in response to a finger 495 contacting the application window at a location within the drawing area 398 outside the contextual menu view object 416 (not shown). As a result, the contextual menu view object 416 is dismissed. However, the contextual menu view object 414 is still displayed in the application window 392 because it is associated with a different user ID, namely pen tool 480.

The application program may comprise program modules including routines, programs, object components, data structures, and the like, and may be embodied as computer readable program code stored on a non-transitory computer readable medium. The computer readable medium is any data storage device that can store data. Examples of computer readable media include for example read-only memory, random-access memory, CD-ROMs, magnetic tape, USB keys, flash drives and optical data storage devices. The computer readable program code can also be distributed over a network including coupled computer systems so that the computer readable program code is stored and executed in a distributed fashion.

Those of ordinary skill in the art will understand that other embodiments are possible. For example, although in embodiments described above, the mouse and keyboard are associated with the user ID NoUserID, in other embodiments, mouse input may alternatively be treated as input from a user having a user ID other than NoUserID, and therefore with a distinguishable identity. As will be understood, in this alternative embodiment, a menu opened in response to mouse input, for example, cannot be dismissed by other input, with the exception of input associated with NoUserID, and mouse input cannot dismiss menus opened by other users except those associated with NoUserID. In a related embodiment, the interactive input system may alternatively comprise a plurality of computer mice coupled to the computing device, each of which can be used to generate an individual input event having a unique input ID. In this alternative embodiment, input from each mouse is assigned to a unique user ID to allow menu manipulation.

Although in embodiments described above, the interactive input device comprises input devices that comprise the IWB, the mouse, and the keyboard, in other embodiments, the input devices may comprise any of touch pads, slates, trackballs, and other forms of input devices. In these embodiments, each of these input devices may be associated with either a unique user ID or the NoUserID, depending on interactive input system configuration. In embodiments in which the input devices comprise slates and touch pads, it will be understood that the IDs used in the input events generated by the input interface will comprise {input ID, NULL, contact ID}.

Those skilled in the art will appreciate that, in some other embodiments, the interactive input system 20 may also comprise one or more 3D input devices, whereby the menu structure may be manipulated in response to input received from the 3D input devices.

Although in embodiments described above, the interactive input system comprises a single IWB, the interactive input system may alternatively comprise multiple IWBs, each associated with a unique surface ID. In this embodiment, input events on each IWB are distinguishable, and are associated with a respective user ID for allowing menu manipulation. In a related embodiment, the interactive input system may alternatively comprise no IWB.

Although in embodiments described above, the IWB comprises one interactive surface, in other embodiments, the IWB may alternatively comprise two or more interactive surfaces, and/or two or more interactive surface areas, and where pointer contacts on each surface or each surface area may be independently detected. In this embodiment, each interactive surface, or each interactive surface area, has a unique surface ID. Therefore, pointer contacts on different interactive surfaces, or different surface areas, and which are generated by the same type of pointer (e.g. a finger) are distinguishable, and are associated with a different user ID. IWBs comprising two interactive surfaces on the opposite sides thereof are described in U.S. Application Publication No. 2011/0032215 to Sirotech et al. entitled “INTERACTIVE INPUT SYSTEM AND COMPONENTS THEREFOR”, filed on Jun. 15, 2010, and assigned to SMART Technologies ULC, Calgary, Alberta, Canada, the content of which is incorporated herein by reference in its entirety. IWBs comprising two interactive surfaces on the same side thereof have been previously described in U.S. Application Publication No. 2011/0043480 to Popovich et al. entitled “MULTIPLE INPUT ANALOG RESISTIVE TOUCH PANEL AND METHOD OF MAKING SAME”, filed on Jun. 25, 2010, and assigned to SMART Technologies ULC, Calgary, Alberta, Canada, the content of which is incorporated herein by reference in its entirety.

In some alternative embodiments, the interactive input system is connected to a network and communicates with one or more other computing devices. In these embodiments, a computing device may share its screen images with other computing devices in the network, and allows other computing devices to access the menu structure of the application program shown in the shared screen images. In this embodiment, the input sent from each of the other computing devices is associated with a unique user ID.

In embodiments described above, the general purpose computing device distinguishes between different pointer types by differentiating the curve of growth of the pointer tip. However, in other embodiments, other approaches may be used to distinguish between different types of pointers, or even between individual pointers of the same type, and to assign user IDs accordingly. For example, in other embodiments, active pen tools are used, each of which transmits a unique identity in the form of a pointer serial number or other suitable identifier to a receiver coupled to IWB 22 via visible or infrared (IR) light, electromagnetic signals, ultrasonic signals, or other suitable approaches. In a related embodiment, each pen tool comprises an IR light emitter at its tip that emits IR light modulated with a unique pattern. An input ID is then assigned to each pen tool according to its IR light pattern. Specifics of such pen tools configured to emit modulated light are disclosed in U.S. Patent Application Publication No. 2009/0278794 to McReynolds et al., assigned to SMART Technologies ULC, Calgary, Alberta, Canada, the assignee of the subject patent application, the content of which is incorporated herein in its entirety. Those skilled in the art will appreciate that other approaches are readily available to distinguish pointers, such as for example by differentiating pen tools having distinct pointer shapes, or labeled with unique identifiers such as RFID tags, barcodes, color patterns on pen tip or pen body, and the like. As another example, if the user is wearing gloves having fingertips that are treated so as to be uniquely identifiable (e.g. having any of a unique shape, color, barcode, contact surface area, emission wavelength), then the individual finger contacts may be readily distinguished.

Although in embodiments described above, the IWB 22 identifies the user of an input according to input ID and surface ID, in other embodiments, the interactive input system alternatively comprises an interactive input device configured to detect user identity in other ways. For example, the interactive input system may alternatively comprise a DiamondTouch™ table offered by Circle Twelve Inc. of Framingham, Mass., U.S.A. The DiamondTouch™ table detects the user identity of each finger contact on the interactive surface (configured in a horizontal orientation as a table top) by detecting signals capacitively coupled through each user and the chair on which the user sits. In this embodiment, the computing device to which the DiamondTouch™ table is coupled assigns user ID to pointer contacts according to the user identity detected by the DiamondTouch™ table. In this case, finger contacts from different users and not necessarily different input sources, are assigned to respective user IDs to allow concurrent menu manipulation as described above.

Although in embodiments described above, user ID is determined by the input interface 102, in other embodiments, user ID may alternatively be determined by the input devices or firmware embedded in the input devices.

Although in embodiments described above, the menu structure is implemented in an application program, in other embodiments, the menu structure described above may be implemented in other types of windows or graphic containers such as for example, a dialogue box, or a computer desktop.

Although in embodiments described above, two users are shown manipulating menus at the same time, those of skill in the art will understand that more than two users may manipulate menus at the same time.

Although in embodiments described above, input associated with the user ID NoUserID dismisses menus assigned to other user IDs, and menus assigned to NoUserID may be dismissed by input associated with other user IDs, in other embodiments, input associated with ID NoUserID alternatively cannot dismiss menus assigned to other user IDs, and menus assigned to NoUserID alternatively cannot be dismissed by inputs associated with other user IDs. In this embodiment, a “Dismiss all menus” command may be provided as, for example, a toolbar button, to allow a user to dismiss menus popped up by all users.

Although in embodiments described above, a graphic object is selected by an input event, and a contextual menu thereof is opened in response to a next input event having the same user ID, in other embodiments, each user may alternatively select multiple graphic objects to form a selection set of his/her own, and then open a contextual menu of the selection set. In this case, the selection set is established without affecting other users' selection sets, and the display of the contextual menu of a selection set does not affect the contextual menus of other selection sets established by other users except those associated with NoUserID. The specifics of establishing multiple selection sets is disclosed in the above-incorporated U.S. Provisional Application No. 61/431,853.

Those skilled in the art will appreciate that the class architecture described above is provided for illustrative purposes only. In alternative embodiments, other coding architectures may be used, and the application may be implemented using any suitable object-oriented or non-object oriented programming language such as, for example C, C++, Visual Basic, Java, Assembly, PHP, Perl, etc.

Although in embodiments described above, the application layer comprises an application program, in other embodiments, the application layer may alternatively comprise a plurality of application programs.

Those skilled in the art will appreciate that user IDs may be expressed in various ways. For example, a user ID may be a unique number in one embodiment, or a unique string in an alternative embodiment, or a unique combination of a set of other IDs, e.g., a unique combination of surface ID and input ID, in another alternative embodiment.

Although embodiments have been described above with reference to the accompanying drawings, those of skill in the art will appreciate that variations and modifications may be made without departing from the scope thereof as defined by the appended claims.

What is claimed is:

1. A method comprising:
receiving an input event associated with a first user ID, the input event being a command for displaying a first menu on a display surface;
identifying a second menu associated with the first user ID currently being displayed on the display surface;
dismissing the second menu; and
displaying the first menu.

2. A method according to claim 1, further comprising:
receiving an input event associated with a second user ID, the input event being a command for displaying a third menu on the display surface;
identifying a fourth menu associated with the second user ID currently being displayed on the display surface;
dismissing the fourth menu; and
displaying the third menu.

3. A method according to claim 1, further comprising:
identifying a third menu currently being displayed on the display surface and being associated with a second user ID; and
dismissing the third menu.

4. A method according to claim 3, wherein the second user ID is associated with one of a mouse and a keyboard.

5. A method according to claim 1, wherein the first user ID is associated with an input ID and a display surface ID.

6. A method according to claim 5, wherein the input ID identifies the input source.

7. A method according to claim 5, wherein the display surface ID identifies an interactive surface on which pointer input is received.

8. A method according to claim 1, wherein the first and second menus comprise one of a main menu bar, a contextual menu, and a toolbar menu.

9. An interactive input system comprising:
at least one interactive surface; and
processing structure in communication with said at least one interactive surface and being configured to:
generate an input event associated with a first user ID, the input event being a command for displaying a first menu on the interactive surface;
identify a second menu associated with the first user ID currently being displayed on the interactive surface;
dismiss the second menu; and
display the first menu.

10. A system according to claim 9, wherein the processing structure is further configured to:
generate an input event associated with a second user ID, the input event being a command for displaying a third menu on the interactive surface;
identify a fourth menu associated with the second user ID currently being displayed on the interactive surface;
dismiss the fourth menu; and
display the third menu.

11. A system according to claim 9, wherein the processing structure is further configured to:
identify a third menu currently being displayed on the interactive surface and being associated with a second user ID; and
dismiss the third menu.

12. A system according to claim 11, further comprising a mouse and/or a keyboard, wherein the second user ID is associated with the mouse and/or the keyboard.

13. A system according to claim 9, wherein the first user ID is associated with an input ID and a surface ID.

14. A system according to claim 13, wherein the input ID identifies the input source.

15. A system according to claim 13, wherein the surface ID identifies the interactive surface on which pointer input is received.

16. A system according to claim 9, wherein the first and second menus comprise one of a main menu bar, a contextual menu, and a toolbar menu.

17. A system according to claim 9, wherein the at least one interactive surface comprises at least two interactive surfaces.

18. A non-transitory computer-readable medium having embodied thereon a computer program comprising instructions which, when executed by processing structure, carry out the steps of
receiving an input event associated with a first user ID, the input event being a command for displaying a first menu on a display surface;
identifying a second menu associated with the first user ID currently being displayed on the display surface;
dismissing the second menu; and
displaying the first menu.

19. An apparatus comprising:
processing structure; and
memory storing program code, which when executed by the processing structure, causes the processing structure to direct the apparatus to:
in response to receiving an input event associated with a first user ID representing a command for displaying a first menu on a display surface, identify a second menu associated with the first user ID currently being displayed on the display surface;
dismiss the second menu; and
display the first menu.

20. An apparatus according to claim 19, where, in response to receiving an input event associated with a second user ID and a command for displaying a second menu on the display surface, execution of the program code by the processing structure further causes the processing structure to direct the apparatus to:
identify a fourth menu associated with the second user ID currently being displayed on the display surface;
dismiss the fourth menu; and
display the third menu.

21. An apparatus according to claim 19, wherein execution of the program code by the processing structure further causes the processing structure to direct the apparatus to:
identify a third menu currently being displayed on the display surface and being associated with a second user ID; and
dismiss the third menu.

22. An apparatus according to claim 21, further comprising a mouse and/or a keyboard, wherein the second user ID is associated with the mouse and/or the keyboard.

23. An apparatus according to claim 19, wherein the first user ID is associated with an input ID and a display surface ID.

24. An apparatus according to claim 23, wherein the input ID identifies the input source.

25. An apparatus according to claim 23, wherein the display surface ID identifies an interactive surface on which pointer input is received.

26. An apparatus according to claim 19, wherein the first and second menus comprise one of a main menu bar, a contextual menu, and a toolbar menu.
